(19) United States
(12) Patent Application Publication
(10) Pub. No.: US 2020/0093074 A1
(43) Pub. Date: Mar. 26, 2020

(54) A SYSTEM FOR GRINDING STUMPS AND CLEARING BRUSH, AND RELATED METHODS AND DEVICES

(71) Applicant: Keith Cairns, Olympia, WA (US)

(72) Inventor: Keith Cairns, Olympia, WA (US)

(21) Appl. No.: 16/616,206

(22) PCT Filed: May 23, 2018
(86) PCT No.: PCT/US18/34062

§ 371 Date: Nov. 22, 2019

Related U.S. Application Data
(60) Provisional application No. 62/510,401, filed on May 24, 2017.

(51) Int. Cl. A01G 23/06; B23D 35/00

(52) U.S. Cl. CPC A01G 23/067; B23D 35/004; B23D 35/001

(57) ABSTRACT

A cutting system includes a wheel, a tooth and a fastener. The wheel has a hub, a periphery, a side that extends from the hub to the periphery, and a receiver located on the wheel's side. The hub has a longitudinal axis about which the wheel may rotate, and the receiver includes a bearing surface. The tooth is mounted to the wheel's receiver and includes a blade and a mount. The blade cuts material when the wheel rotates about the hub's longitudinal axis and the blade contacts the material. The mount couples the blade to the wheel's receiver. The mount includes a first interface where the blade couples with the mount, and a second interface where the mount couples with the wheel's receiver. The mount's second interface is configured to mimic and nest with the wheel's receiver and includes a bearing surface that transmits to the bearing surface of the wheel's receiver loads that the material exerts on the blade while the blade cuts the material. The fastener secures the tooth to the wheel and holds the bearing surface of the mount's second interface against the bearing surface of the wheel's receiver, and specifically does not include the bearing surface of the tooth's mount.

### BACKGROUND

Systems for grinding away a tree stump, clearing thick brush, clearing dirt, or even digging a trench typically include teeth mounted to a wheel that is coupled to a motor. The motor rotates the wheel with enough torque and speed to cut through the wood or dirt. Because the system grinds away the wood or dirt, the teeth make many passes through the material to remove the stump, brush or dirt desired for removal. This, in turn, requires substantial power from the motor to keep the wheel rotating with enough speed to continue to grind away the material. The many passes through the material that a tooth makes also causes substantial wear to the teeth and the wheel. As the teeth wear, they become less effective at cutting through the material and in turn require more power from the motor. More power from the motor, in turn, can cause the teeth to experience substantial impact loads, such as when the teeth hit a rock or a particularly dense section of wood in a stump, which can damage the wheel where the teeth are mounted.

Thus, there is a need for a cutting system that can effectively grind away a tree stump, clear thick brush, clear dirt or dig a trench while reducing the power needed from the motor and while reducing wear damage to the teeth and wheel.

### SUMMARY

In one aspect of the invention, a cutting system for grinding stumps and cutting brush includes a wheel, a tooth and a fastener. The wheel has a hub, a periphery, a side that extends from the hub to the periphery, and a receiver located on the wheel's side. The hub has a longitudinal axis about which the wheel may rotate, and the receiver includes a bearing surface. The tooth is mounted to the wheel's receiver and includes a blade and a mount. The blade cuts material when the wheel rotates about the hub's longitudinal axis and the blade contacts the material. The mount couples the blade to the wheel's receiver. The mount includes a first interface where the blade couples with the mount, and a second interface where the mount couples with the wheel's receiver. The mount's second interface is configured to mimic and nest with the wheel's receiver and includes a bearing surface that transmits to the bearing surface of the wheel's receiver loads that the material exerts on the blade while the blade cuts the material. The fastener secures the tooth to the wheel and holds the bearing surface of the mount's second interface against the bearing surface of the wheel's receiver, and specifically does not include the bearing surface of the tooth's mount.

With the bearing surfaces of the mount and wheel's receiver configured to mimic and nest with each other, the loads that the blade of the tooth experiences while grinding through a tree stump, thick brush or dirt may be transmitted from the mount to the wheel via the bearing surfaces. This effectively separates the regions of the mount and wheel that experience the shear loads transmitted from the blade, from the regions of the mount, wheel and fastener that experience tensile loads from securing the mount to the wheel. Consequently, the fastener carries a shear load across its shank that is significantly reduced if not minimal, and much of the shear loads transmitted from the tooth's blade are converted into compressive loads and carried over the bearing surfaces' large area. This in turn reduces possible damage to the wheel and the tooth's mount, which may reduce the amount of horsepower required to effectively use the wheel and tooth to grind stumps, thick brush, or dirt.

In another aspect of the invention, a tooth for grinding stumps and cutting brush includes a blade that cuts material when the blade is urged through the material, a mount that is operable to couple the blade to a wheel of a cutting system, and a hole. The mount includes a first interface where the blade couples with the mount, a second interface operable to couple the mount with the wheel. The second interface is configured to mimic and nest with a receiver of the wheel and includes a bearing surface that transmits to the wheel's receiver loads that the material exerts on the blade while the blade cuts the material. The tooth's hole extends through the mount and is sized to receive and hold a fastener when the mount is secured to the cutting system's wheel.

In yet another aspect of the invention, a wheel for grinding stumps and cutting brush includes a hub having a longitudinal axis about which the wheel rotates; a periphery; a side that extends from the hub to the periphery; and a receiver located on the side. The receiver is configured to mimic and nest with a second interface of a tooth's mount and includes a bearing surface that receives from the mount's second interface loads that the material exerts on the blade while the blade cuts the material. The wheel also includes a hole that extends into the wheel and is sized to receive and hold a fastener when the tooth's mount is secured to the cutting system's wheel.

### BRIEF DESCRIPTION OF THE DRAWINGS

FIG. 1 shows a perspective view of a cutting system, according to an embodiment of the invention.

FIG. 2 shows and exploded, perspective view of a portion of a wheel shown in FIG. 1 and a portion of a tooth's mount also shown in FIG. 1, according to an embodiment of the invention.

FIG. 3 shows an exploded, partial cross-sectional view of a tooth's mount and a portion of the wheel shown in FIG. 1, according to an embodiment of the invention.

Each of FIGS. 4A-4D shows a view, that is different than the other three views, of a tooth's mount shown in FIGS. 1 and 2, according to an embodiment of the invention.

FIG. 5 shows a perspective view of a tooth's mount, according to another embodiment of the invention.

FIG. 6 shows a perspective view of a tooth's blade, according to yet another embodiment of the invention.

FIG. 7 shows a perspective view of a wheel, according to another embodiment of the invention.

### DETAILED DESCRIPTION

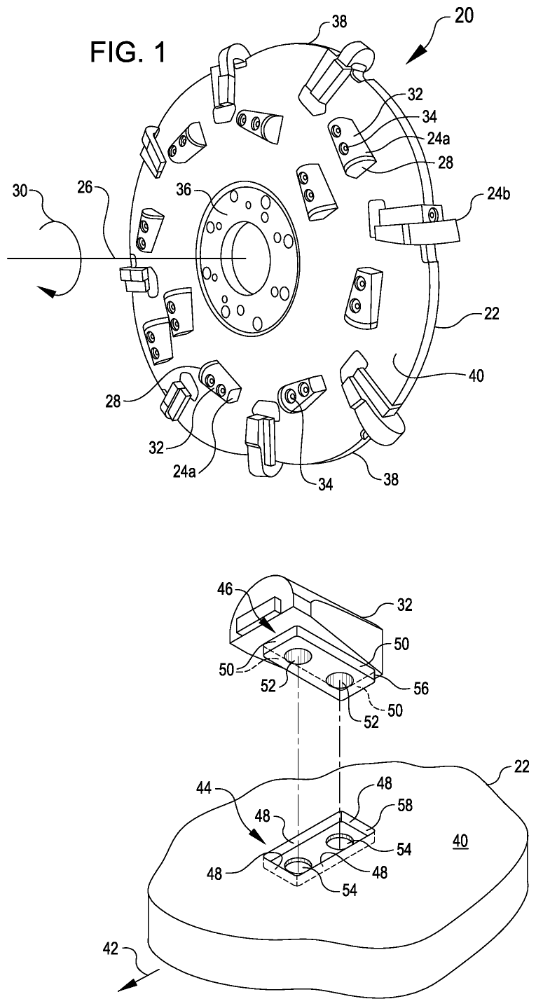

FIG. 1 shows a perspective view of a cutting system 20, according to an embodiment of the invention. The system 20 includes a wheel 22 and teeth 24 (eighteen shown but only three labeled for clarity) mounted to the wheel 22. When the system 20 is coupled to a motor that rotates the wheel 22 about the longitudinal axis 26 of the wheel's hub 28, the system may be used to grind away a stump, clear brush and/or dirt, and even dig a trench (not shown). The system 20 includes two different sets of teeth 24. The first set of teeth 24a (ten shown but only two labeled for clarity) are mounted to the side of the wheel 22. The second set of teeth 24b (eight shown but only one labeled for clarity) are mounted to the periphery of the wheel 22. The teeth 24a are typically used to cut up and grind thick brush by moving the wheel 22 in a direction along the longitudinal axis 26 while rotating the wheel 22. The teeth 24b are typically used to grind away a stump by moving the wheel against the stump such that the teeth 24b on the periphery contact the stump and then moving the wheel 22 back and forth across the stump. In some uses the teeth 24a on the side of the wheel 22 may also grind away a stump when the teeth 24b on the periphery of the wheel 22 cut deep enough into the stump such that when the wheel 22 is moved in a direction along the longitudinal axis 26, the teeth 24a contact the stump.

Other embodiments are possible. For example, the system 20 may include more or fewer teeth 24, and may include more or fewer teeth 24a, as well as more or fewer teeth 24b. For another example, teeth 24a may also be coupled to the other side of the wheel 22—the side of the wheel 22 not shown. For yet another example, the system 20 may include a wheel 22 capable of having eight teeth 24b coupled at the wheel's periphery and ten teeth 24a coupled at the side 40 of the wheel 22, and yet have fewer teeth 24b coupled to the wheel's periphery and fewer teeth 24a coupled to wheel's side 40.

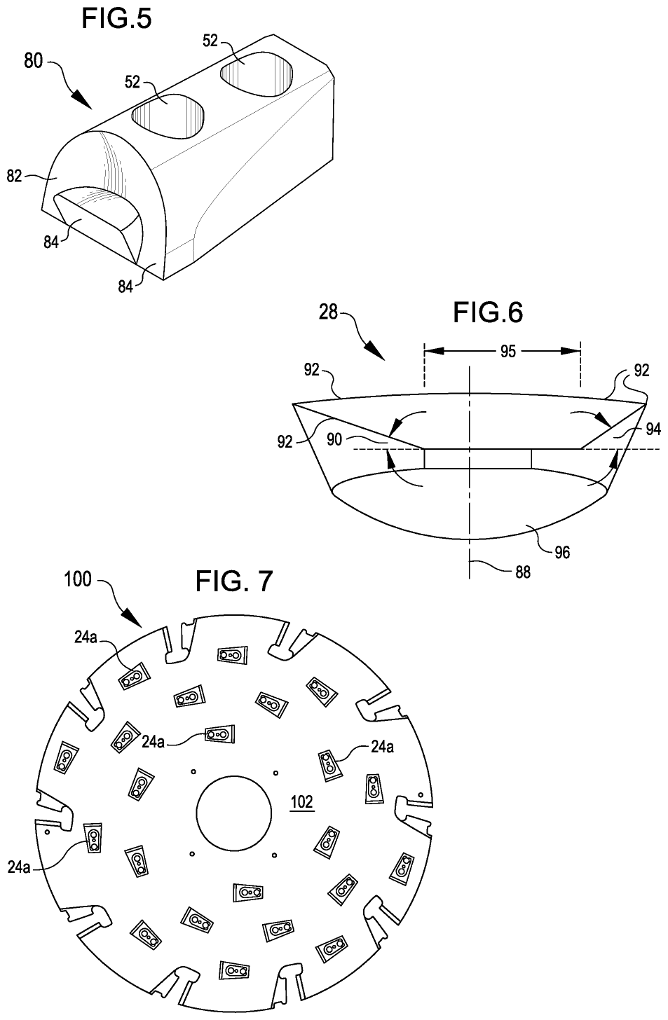

Still referring to FIG. 1, each of the teeth 24a includes a blade 28 to cut material when the wheel 22 rotates about the longitudinal axis 26 in the direction indicated by the arrow 30, a mount 32 to couple the blade 28 to the wheel 22, and a fastener 34 to secure the tooth 24a to the wheel 22. The blade 28 may be similar to the cutting element shown and discussed in U.S. Patent Application Publication 2013/0306775 A1, now U.S. Pat. No. 9,686,922 issued 27 Jun. 2017, which is incorporated in this patent application by this reference for all that it discloses, or the blade 28 may be configured as shown in FIG. 6 and discussed in conjunction with FIG. 6. As discussed in greater detail in conjunction with FIG. 2, both the mount 32 and the wheel 22 are configured to contact and hold the other so that shear loads experienced by the blade 28 while the blade 28 cuts through material are not transmitted to the wheel 22 via the fastener 34, but rather are transmitted directly to the wheel 22. This effectively separates the regions of the mount 32 and wheel 22 that carry the shear loads transmitted from the blade 28, from the regions of the mount 32, wheel 22 and fastener 34 that carry tensile loads while securing the mount 32 to the wheel 22. Consequently, the fastener 34 carries a shear load across its shank that is significantly reduced if not minimal, and much of the shear loads transmitted from the tooth's blade 28 are converted into compressive loads and carried over a larger area of the mount 32 and wheel 22. This in turn reduces possible damage to the wheel 22 and the tooth's mount 34, which may reduce the amount of horsepower required to effectively use the wheel 22 and tooth 24a to grind stumps, thick brush, or dirt.

The teeth 24a may be arranged on the wheel 22 as desired. For example, in this and other embodiments the wheel 22 includes a hub 36, a periphery 38, and a side 40 that extends from the hub 36 to the periphery 38 and on which two sets of five teeth 24a are arranged in a spiral that extends 180 degrees around the hub 36. Each spiral starts near the hub 36 and 180 degrees away from the other, and each tooth 24a of each spiral is spaced apart from its adjacent tooth 24a in the same spiral, such that the last tooth 24a in each of the spirals lies, in a radial direction, next to the first tooth 24a of the other spiral. With the teeth 24a so arranged, the amount of horsepower required to effectively use the system 20 to grind stumps or other materials is much less than the amount of horsepower required for other, conventional stump-grinding wheels. In addition, the arrangement of the teeth 24a also enables one to direct the direction that the system 20 expels the chips of material.

In other embodiments, the teeth 24a may be arranged on the wheel's side 40 such that together they form one or more “X” patterns whose centers are not located where the longitudinal axis 26 is located. As another example, the teeth 24a may be arranged on the wheel's side 40 such that they form one or more “V” patterns with the point of the “V” pointed in the direction that the disk 26 rotates while grinding or cutting material. As yet another example, the teeth 24a may be staggered in the direction that the wheel 22 rotates, relative to their respective, radially-adjacent teeth 24a.

Still referring to FIG. 1, the teeth 24b mounted to the periphery of the wheel 22 may be configured as desired and mounted as desired. For example, in this and other embodiments of the system 20, each of the teeth 24b are configured and mounted to the wheel 22 as shown and discussed in U.S. Patent Application Publication 2013/0306775 A1, now U.S. Pat. No. 9,686,922 issued 27 Jun. 2017.

Still referring to FIG. 1, the wheel 22 may be configured as desired. For example, in this and other embodiments the wheel 22 is substantially circular and has a diameter of about 18 inches. The wheel 22 is not completely circular because the section of the periphery 38 between each set of adjacent teeth 24b is not a consistent radial distance from the axis 26. The radial distance for the region of each section that is immediately in front of the tooth 24b as the wheel rotates in the direction indicated by the arrow 30, is less by about one inch than the radial distance of the region of each section that is immediately behind the tooth 24b. In other embodiments, however, the wheel 22 may be circular or any other shape.

FIG. 2 shows an exploded, perspective, view of a portion of the wheel 22 shown in FIG. 1 and a portion of a mount 32 also shown in FIG. 1, according to an embodiment of the invention. When the wheel 22 rotates about the axis 26 (FIG. 1) to grind a stump and/or clear brush, the wheel 22 rotates in the direction indicated by the arrow 42. Both the wheel 22 and the mount 32 are configured to contact and hold the other so that shear loads experienced by the blade 28 (FIG. 1) while the blade 28 cuts through material are not transmitted to the wheel 22 via the fastener 34 (FIG. 1), but rather are transmitted directly to the wheel 22.

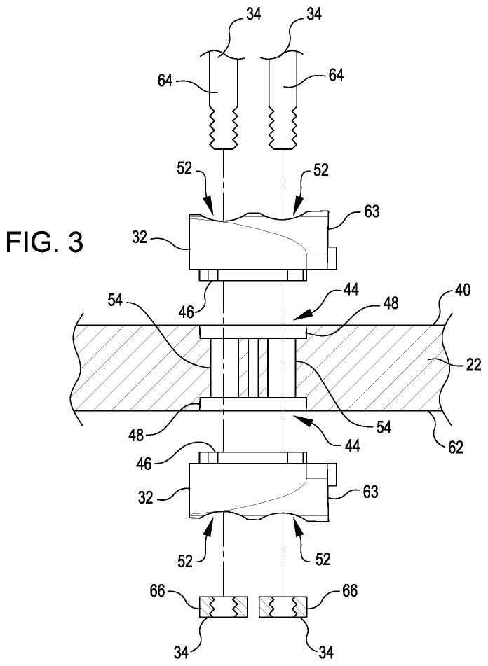

More specifically, the wheel 22 includes a receiver 44 that is located on the wheel's side 40, and the mount 32 includes a second interface 46 (the mount's first interface is shown and discussed in conjunction with FIGS. 3-5). The receiver 44 and the second interface 46 mimic each other such that they nest with each other when the mount 32 is coupled to the wheel 22. The receiver 44 includes a bearing surface 48, and the second interface 46 includes a bearing surface 50. When the mount 32 is coupled to the wheel 22 and the wheel 22 is used to grind a stump, clear brush and/or dirt, the mount's bearing surface 50 contacts the receiver's bearing surface 48 and transmits loads that the stump, brush and/or dirt exert on the blade while the blade cuts through the stump, brush and/or dirt. By transmitting these loads directly from the mount's second interface 46 to the wheel's receiver 44, the fastener (here two) that extends into a respective one of the holes 52 in the mount 32 and through a respective one of the holes 54 in the wheel 22 do not carry these loads. Instead, the fastener 34 carries a predominantly tensile load generated by securing the mount's second interface 46 in the wheel's receiver 44, and thus the tooth 24a to the wheel 22.

The receiver 44 and the mount's second interface 46 may be configured as desired. For example, in this and other embodiments, the receiver 44 includes a cavity that is rectangular; and the mount's second interface 46 includes a land that is rectangular and nests in the cavity when the mount 32 is coupled to the wheel 22. Each of the receiver's bearing surface 48 and the second interface's bearing surface 50 is flat and surrounds their respective holes 54 and 52. In addition, the bearing surfaces 48 and 50 are oriented such that they lay parallel to the wheel's longitudinal axis 46. In this configuration, the region 56 of the mount's bearing surface 50 that transfers much of the shear load experienced by the blade 28 as the blade 28 cuts through material is defined by a vector that is normal (perpendicular) to the bearing surface 50 in the region 56 and that extends in the direction opposite the direction 42 that the wheel 22 rotates when in use. This allows the region 56 of the mount's bearing surface 50 to exert a substantially normal (perpendicular) force on the region 58 of the receiver's bearing surface 48. By doing this, most if not all of the load transferred through these regions 56 and 58 do not generate a tensile or a compressive load in the fastener 34. Instead, the load generated in the wheel 22 adjacent the receiver 44 is predominantly compression and shear in the direction opposite the direction 42 that the wheel 22 rotates. This configuration also reduces a twisting deflection in the tooth 24a that can force the tooth's blade 28 (FIG. 1) out of its proper alignment with the rotation of the wheel 22, which in turn can adversely affect the cutting geometries of the tooth's blade 28.

The receiver 44 and the second interface 46 may be sized as desired to have the bearing surfaces carry any desired stress while the blade 28 cuts through material. For example, in this and other embodiments the total area of each of the bearing surfaces 48 and 50 is larger than the total cross-sectional area of the fastener's shank. More specifically, the perimeter of the second interface's land is 3.75 inches, and the height of the land is 0.25 inches. By increasing the area of each of the bearing surfaces 48 and 50, one can reduce the stress experienced by each of the surfaces 48 and 50 while the mount's bearing surface 50 transfers loads to the receiver's bearing surface 48. To increase the total area of each of the bearing surfaces 48 and 50, the perimeter of the receiver's cavity and the perimeter of the second interface's land may be increased, the depth of the receiver's cavity and the depth of the second interface's land may be increased, or both may be increased. To increase the stress experienced by each of the bearing surfaces 48 and 50, the area of each may be decreased by shortening the perimeter of the second interface's land, shortening the height of the land, or shortening both.

Other embodiments are possible. For example, the mount's second interface 46 may include a cavity and the receiver 44 may include a land that nests in the cavity when the mount 32 is coupled to the wheel 22. For another example, the configuration of the receiver 44 and the second interface 46 may be any shape other than rectangular, such as oval, triangular, hexagonal, and star-shaped to allow one to clock a tooth 24a to accommodate a specific blade 28 coupled to the mount 32. For another example, the bearing surfaces 48 and 50 may be oriented so that they are not parallel with the wheel's longitudinal axis 26 but may instead be oriented so that they would intersect the longitudinal axis if they extended far enough. Such an orientation may be desirable to convert some of the shear load experienced by the blade 28 while it cuts through material into a tensile or compressive load generated adjacent the receiver 44, and in a direction other than the direction 42 that the wheel 22 rotates. This in turn may allow one to use some of the generated loads to offset or cancel other loads generated in the wheel 22 or tooth 24a.

FIG. 3 shows an exploded, partial cross-sectional view of a mount 32 of a tooth 24a and a wheel 22 shown in FIG. 1, according to an embodiment of the invention. In this embodiment, two mounts 32, and thus two teeth 24a, are coupled to the wheel 22 on opposite sides of the wheel 22. One of the mounts 32 is coupled to the wheel's side 40, and the other mount 32 is coupled to the side 62 of the wheel. In addition, each mount includes a first interface 63 where the blade 28 (FIG. 1) couples with the mount 32.

Each of the mounts 32 may be secured to the wheel 22 in any desired manner. For example, in this and other embodiments each of two fasteners 34 extend through a respective hole 52 in both of the mounts 32 and through a respective hole 54 in the wheel 22. More specifically, each of the holes 54 extend through the wheel 22 from the side 40 to the other side 62; and a bolt 64 of each fastener 34 extends through a respective one of the two holes 52 in the mount 32 that is coupled to the wheel's side 40, through a respective one of the two holes 54, and into a respective one of the two holes 52 in the mount 32 that is coupled to the wheel's side 62. Two nuts 66 then threadingly engage the two bolts 64, each nut 66 threadingly engaging a respective one of the two bolts 64, to secure both mounts 32 to the wheel 22.

The bolts 64 and the nuts 66 may be sized and configured as desired to secure both mounts 32 to wheel 22 while the mounts experience loads in operation. For example, in this and other embodiments, each bolt and nut are made of 4140 alloy steel. Each bolt 64 is two inches long, has a diameter of 0.5 inches, and includes thirteen course threads per inch; and each nut 66 is configured to threadingly engage the bolt 64.

Other embodiments are possible. For example, the two mounts 32 may be secured to each other with fasteners that do not require the nuts 66. Instead, each of the bolts 64 may threadingly engage internal threads of a respective one of the holes 52 in the other mount 32. For another example, in embodiments in which all of teeth 24a are coupled to the same side of the wheel 22, the mounts 32 may be secured to the wheel 22 via fasteners 34 that do not extend through the wheel 22 and include a nut 66, but rather threadingly engage internal threads located inside the holes 54. In these embodiments the holes 54 may extend through the wheel 22 to both sides 40 and 62 of the wheel 22, or they may remain blind (not extend to both sides 40 and 62 of the wheel 22). For yet another example, the mounts may be secured to the wheel 22 with fewer than or more than two fasteners. For yet another example, one or more of the mounts 32 may be coupled to the wheel 22 with other types of fasteners, such as rivets; or they may be welded to the wheel 22 to more permanently fix them to the wheel 22.

Each of FIGS. 4A-4D shows a view, that is different than the other three views, of a tooth's mount 32 shown in FIGS. 1 and 2, according to an embodiment of the invention.

The mount 32 may be configured as desired. For example, in this and other embodiments, the mount 32 includes a body 70, the second interface 46, the holes 52, and the first interface 63 to which a blade 28 (FIG. 1) is coupled. The interface 63 includes a surface 72 that is substantially flat and oriented relative to the second interface 46, such that when the mount 32 is secured to the wheel 22, the surface 72 lies substantially perpendicular to the wheel 22. In other embodiments, the interface 72 lies at an angle other than ninety degrees relative to the wheel 22. In still other embodiments, the interface 72 lies at any angle about the axis 74.

The mount 32 may be made of any desired material capable of withstanding the loads and environment that it will experience while grind a stump, clearing brush and dirt, and digging a trench. For example, in this and other embodiments the mount 32 includes 1018 alloy steel. In other embodiments, the mount 32 may include 4140 alloy steel. In addition, the blade 28 (FIG. 1) may be releasably coupled with the mount at the first interface 63 or more permanently fixed to the first interface 63.

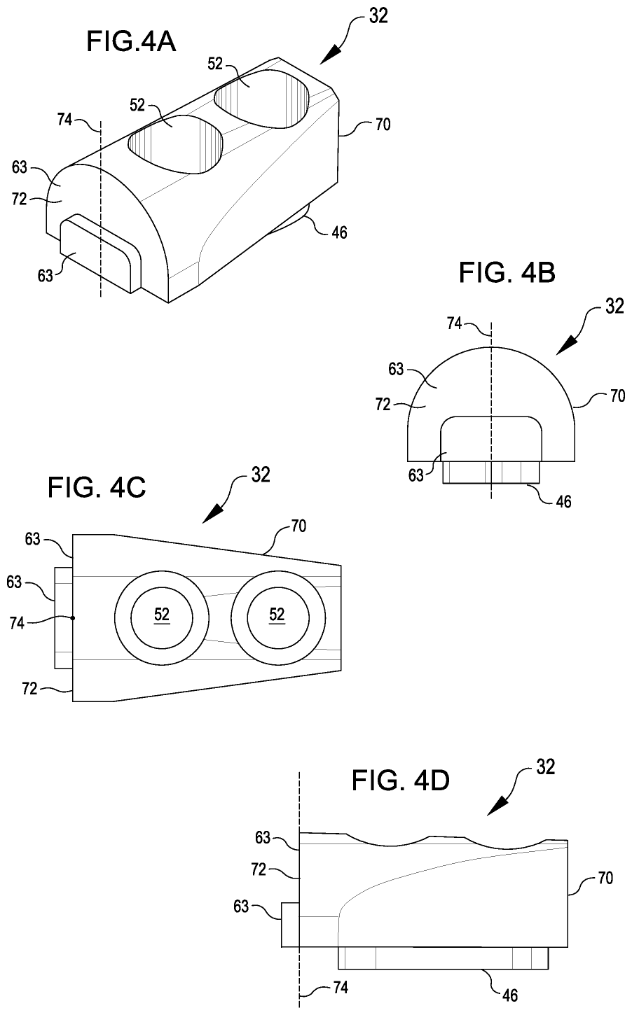

FIG. 5 shows a perspective view of a tooth's mount 80, according to another embodiment of the invention. The mount 80 is similar to the mount 32 shown in FIGS. 1-4D except that the surface 82 of the first interface 84 is curved, not substantially flat. The curve may be any desired curve that allows one to easily position a blade 28 (FIGS. 1 and 6) to have any desired rake angle with any desired blade geometry. That is, a blade having a variety of different cutting-edge configurations and/or geometries can still be positioned on the mount 80 to provide any desired rake angle or cutting geometry. In this and other embodiments, the curve of surface 82 is concave and spherical to allow a spherical contact area of the blade and/or the blade's mounting block. In other embodiments, the curve of the surface 82 is convex.

FIG. 6 shows a perspective view of a blade 28, according to yet another embodiment of the invention. The blade 28 may be configured as desired. For example, in this and other embodiments the blade 28, unlike the cutting element shown in the attached U.S. Patent Application Publication 2013/0306775 A1, is not symmetrical about the axis 88. Furthermore, the blade 28 may be asymmetrical about the axis 88 in any desired manner. For example, in this and other embodiments the asymmetry is as shown in FIG. 6. With the shallower angle 90 to the cutting edge 92, the steeper angle 94 to the cutting edge 92, and the region 95 through which the shallower angle 90 transitions into the steeper angle 94, the amount of horsepower needed to drive the blade 28 through the material and/or ground is less than the amount of horsepower needed for a conventional blade. Also, with this asymmetry and the curved surface 82 (FIG. 5) of the mount 80 (FIG. 5), one can control the direction (radial and axial) that the wheel 22 expels chip and debris, and can provide extended, even wear throughout the life of the blade 28 by having the cutting edge 92 beefed-up in the regions of the blade 28 that are likely to experience more wear while in use.

As previously mentioned, the blade 28 may be fixed or releasably coupled with the first interface 63 of the mount 32 or the first interface 84 of the mount 80. For example, in this and other embodiments, the blade 28 includes a curved surface 96 that is welded onto the curved surface 82 (FIG. 5) of the mount 80 (FIG. 5). In other embodiments of the blade 28 may include a substantially flat region, in lieu of the curved surface 96, to facilitate mounting the blade 28 to the first interface 63 (FIGS. 1-4D) of the mount 32 (FIGS. 1-4D). To releasably couple the blade 28 to the mount 32 or 80, one or bolts may hold the blade 28 onto the first interface 63 or 84.

FIG. 7 shows a perspective view of a wheel 100, according to another embodiment of the invention. The wheel 100 is similar to the wheel 22 shown in FIG. 1, except the wheel 100 includes twenty-two receivers (not shown) on the side 102 of the wheel 100, each of which has a respective one of twenty-two teeth 24a (only four labeled for clarity) coupled to it, not ten like the wheel 22. The wheel 100 has a diameter of 30 inches, and another twenty-two receivers located on the side of the wheel 100 not shown. Another twenty-two teeth 24a (not shown), each of which is coupled to a respective one of the other twenty-two receivers not shown, and each of which is located directly opposite a respective one of the twenty-two teeth 24a that are shown. Although the teeth 24a are arranged on each side of the wheel 100 in two spirals, each of which includes eleven teeth 24a, all forty-four teeth 24a that are coupled to the wheel 100 may be arranged as desired.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A tooth for a cutting system for grinding stumps and cutting brush, the tooth comprising:
a blade that cuts material when the blade is urged through the material; and
a mount that is operable to couple the blade to a wheel of the cutting system, the mount having:
a first interface where the blade couples with the mount,
a second interface operable to couple the mount with the wheel, the second interface being configured to mimic and nest with a receiver of the wheel and includes a bearing surface that transmits to the wheel's receiver loads that the material exerts on the blade while the blade cuts the material, and
a hole that extends through the mount and is sized to receive and hold a fastener when the mount is secured to the cutting system's wheel.

2. The tooth of claim 1 wherein the blade is releasably coupled with the mount's first interface.

3. The tooth of claim 1 wherein mount's second interface includes a cavity that the wheel's receiver nests in.

4. The tooth of claim 1 wherein the mount's second interface includes a land that nests in the wheel's receiver.

5. The tooth of claim 1 wherein the mount's first interface includes a surface that is flat.

6. The tooth of claim 1 wherein the mount's first interface includes a surface that is curved.

7. The tooth of claim 1 wherein the bearing surface of the mount's second interface is flat.

8. The tooth of claim 1 wherein the bearing surface of the mount's second interface is defined by a vector that is normal to the surface, and is oriented such that the vector extends in the direction opposite the direction that the tooth travels when the blade cuts material.

9. The tooth of claim 1 wherein the mount's second interface is rectangular in shape.

10. The tooth of claim 1 wherein the bearing surface of the mount's second interface surrounds the hole.

11. A wheel for a cutting system for grinding stumps and cutting brush, the wheel comprising:
a hub having a longitudinal axis about which the wheel rotates;
a periphery;
a side that extends from the hub to the periphery;
a receiver located on the side and configured to mimic and nest with a second interface of a tooth's mount, wherein the receiver includes a bearing surface that receives from the mount's second interface loads that the material exerts on the blade while the blade cuts the material; and
a hole that extends into the wheel and is sized to receive and hold a fastener when the tooth's mount is secured to the cutting system's wheel.

12. The wheel of claim 11 wherein the wheel is circular.

13. The wheel of claim 11 wherein the wheel's receiver includes a cavity that the mount's second interface nests in.

14. The wheel of claim 11 wherein the wheel's receiver includes a land that nests in the mount's second interface.

15. The wheel of claim 11 wherein the wheel includes twenty-two receivers each located on the side.

16. The wheel of claim 11 wherein the wheel includes forty-four receivers, twenty-two of which are located on the side, and the remaining twenty-two located on a second side of the wheel that also extends from the hub to the periphery.

17. The wheel of claim 11 wherein the wheel includes forty-four receivers, twenty-two of which are located on the side, and the remaining twenty-two located on a second side of the wheel that also extends from the hub to the periphery, with each of the twenty-two receivers being aligned with a respective one of the wheel's remaining twenty-two receivers.

18. A cutting system for grinding stumps and cutting brush, the system comprising:
a wheel having a hub, a periphery, a side that extends from the hub to the periphery, and a receiver located on the side, the hub having a longitudinal axis about which the wheel can rotate, and the receiver includes a bearing surface;
a tooth mounted to the receiver of the wheel, the tooth comprising:
a blade that cuts material when the wheel rotates about the hub's longitudinal axis and the blade contacts the material, and
a mount that couples the blade to the wheel's receiver, the mount having a first interface where the blade couples with the mount and a second interface where the mount couples with the wheel's receiver, wherein the second interface is configured to mimic and nest with the wheel's receiver and includes a bearing surface that transmits to the bearing surface of the wheel's receiver loads that the material exerts on the blade while the blade cuts the material; and
a fastener that secures the tooth to the wheel and holds the bearing surface of the mount's second interface against the bearing surface of the wheel's receiver, wherein the fastener does not include the bearing surface of the tooth's mount.

19. The system of claim 18 wherein the wheel is circular.

20. The system of claim 18 wherein the blade is releasably coupled with the mount's first interface.

22. The system of claim 18 wherein the wheel's receiver includes a cavity that the mount's second interface nests in.

23. The system of claim 18 wherein the wheel's receiver includes a land that nests in the mount's second interface.

24. The system of claim 18 wherein the bearing surface of the mount's second interface is parallel with the longitudinal axis of the wheel's hub.

25. The system of claim 18 wherein the fastener has a cross-sectional area and the bearing surface of the mount's second interface has an area that is greater than the fastener's cross-sectional area.

26. The system of claim 18 wherein the mount's second interface is rectangular in shape.

27. The system of claim 18 wherein when the wheel rotates about the hub's longitudinal axis and the blade contacts the material, the bearing surface of the mount's second interface transmits to the bearing surface of the wheel's receiver all of the loads exerted on the blade in a direction parallel to the wheel's side.

28. The system of claim 18 wherein when the wheel rotates about the hub's longitudinal axis and the blade contacts the material, the fastener experiences only tension while the fastener holds the bearing surface of the mount's second interface against the bearing surface of the wheel's receiver.

29. The system of claim 18 wherein the mount's first interface is parallel with the longitudinal axis of the wheel's hub.

30. The system of claim 18 wherein the wheel includes twenty-two receivers each located on the side.

31. The system of claim 18 wherein the wheel includes forty-four receivers, twenty-two of which are located on the side, and the remaining twenty-two are located on a second side of the wheel that also extends from the hub to the periphery.

32. The system of claim 18 wherein the wheel includes forty-four receivers, twenty-two of which are located on the side, and the remaining twenty-two are located on a second side of the wheel that also extends from the hub to the periphery, with each of the twenty-two receivers being aligned with a respective one of the wheel's remaining twenty-two receivers.

33. The system of claim 18 wherein the fastener includes a shank that extends through the wheel and threadingly engages a nut.

34. The system of claim 18 wherein the fastener includes a shank that extends into and threadingly engages the wheel.

35. The system of claim 18 further comprising a peripheral tooth located at the wheel's periphery.

36. A method for grinding or cutting material, the method comprising:
positioning a blade of a cutting system's tooth into contact with material to be ground or cut, the blade being coupled to a first interface of a mount of the cutting system's tooth, the mount having a second interface that is coupled with a receiver of a wheel of the cutting system, the second interface being configured to mimic and nest with a receiver of the wheel, wherein the second interface includes a bearing surface that transmits to a bearing surface of the wheel's receiver loads that the material exerts on the blade while the blade cuts the material, the tooth being secured to the wheel by a fastener that holds the bearing surface of the mount's second interface against the bearing surface of the wheel's receiver, wherein the fastener does not include the bearing surface of the tooth's mount; and
rotating the wheel about a longitudinal axis of a hub of the wheel, while the blade contacts the material to be ground or cut.

37. The method of claim 36 wherein rotating the wheel while the blade contacts the material includes the bearing surface of the mount's second interface transmitting to the bearing surface of the wheel's receiver all of the loads exerted on the blade in a direction parallel to the wheel's side.

38. The method of claim 36 wherein rotating the wheel while the blade contacts the material includes the fastener experiencing only tension while the fastener holds the bearing surface of the mount's second interface against the bearing surface of the wheel's receiver.
